(19) United States
(12) Patent Application Publication
(10) Pub. No.: US 2009/0169904 A1
(43) Pub. Date: Jul. 2, 2009

(54) BARRIER LAMINATE, GAS-BARRIER FILM, DEVICE AND OPTICAL COMPONENT

(76) Inventor: Makoto YAMADA, Kanagawa (JP)

Correspondence Address: BIRCH STEWART KOLASCH & BIRCH, PO BOX 747, FALLS CHURCH, VA, 22040-0747, US

(21) Appl. No.: 12/343,926

(22) Filed: Dec. 24, 2008

(30) Foreign Application Priority Data
Dec. 27, 2007 (JP) 2007-336104
Feb. 28, 2008 (JP) 2008-047534

(51) Int. Cl. B32B 15/09

(52) U.S. Cl. 428/458

(57) ABSTRACT

A barrier laminate comprising an inorganic layer and an organic layer, wherein the inorganic layer comprises an aluminum compound as a main ingredient thereof, the organic layer is formed by polymerizing a composition containing a monomer having a bi- or more-functional acryloyl group, and the organic layer contains a remaining monomer in at most 1 g/m². The laminate has good barrier properties.

### BACKGROUND OF THE INVENTION

1. Field of the Invention

The present invention relates to a barrier laminate and a gas-barrier film having it on a substrate. The invention also relates to a device and others comprising such a barrier laminate or gas-barrier film used for sealing or as a substrate.

2. Description of the Related Art

Heretofore employed is a gas-barrier film having a barrier laminate formed on a plastic substrate or the like, as a substrate for devices such as organic EL devices. For example, JP-A 2003-48271 and JP-A 2004-244606 describe a gas-barrier film formed by laminating an organic layer, an inorganic layer, an organic layer and an inorganic layer in that order on a resin substrate, wherein the organic layer comprises as the main ingredient thereof a polymer obtained by crosslinking an acryloyl group-having monomer, and the inorganic layer is a silicon compound.

The gas-barrier film described in these references has good barrier properties, but the recent technical progress in the art has come to require gas-barrier films having better barrier properties.

### SUMMARY OF THE INVENTION

The invention is to solve the above-mentioned problem and to provide a gas-barrier film having further better barrier properties.

Taking the above-mentioned problem into consideration, the present inventors have assiduously studied and, as a result, have found that, when an organic layer is formed by polymerizing a composition containing at least one monomer having a bi- or more-functional acryloyl group, and the remaining monomer amount in the organic layer is controlled to be at most 1 g/m², and when an inorganic layer comprising an aluminum compound as the main ingredient thereof is formed, then the barrier properties of the laminate can be remarkably enhanced, and have completed the present invention. Concretely, the invention includes the following:

(1) A barrier laminate comprising at least one inorganic layer and at least one organic layer, wherein the inorganic layer comprises an aluminum compound as a main ingredient thereof, the organic layer is formed by polymerizing a composition containing at least one monomer having a bi- or more-functional acryloyl group, and the organic layer contains a remaining monomer in at most 1 g/m². (2) The barrier laminate of (1), wherein the acryloyl group-having monomer is a hetero ring-containing monomer.

(3) The barrier laminate of (1) or (2), wherein the acryloyl group-having monomer is an isocyanuric acid acrylate or an epoxyacrylate.

(4) The barrier laminate of any one of (1) to (3), wherein the inorganic layer comprises aluminum oxide as a main ingredient thereof.

(5) The barrier laminate of any one of (1) to (4), wherein the inorganic layer is formed by a sputtering method.

(6) The barrier laminate of any one of (1) to (5), wherein the composition containing a monomer having a bi- or more-functional acryloyl group contains a polymerization initiator and the content of the polymerization initiator is at least 1 mol % of the bi- or more-functional acryloyl group-having monomer.

(7) A gas-barrier film comprising a substrate film and, as formed on the substrate film, a barrier laminate of any one of (1) to (6).

(8) A device comprising a gas-barrier film of (7).

(9) A device sealed with a barrier laminate of any one of (1) to (6).

(10) A device comprising a gas-barrier film of (7) as the substrate thereof.

(11) A device sealed with a gas-barrier film of (7).

(12) A device of any one of (8) to (11), wherein the device is an electronic device.

(13) A device of anyone of (8) to (11), wherein the device is an organic EL device.

(14) An optical component comprising the gas-barrier film of (7) as the substrate thereof.

The invention has made it possible to provide a gas-barrier film having excellent barrier properties.

### BEST MODE FOR CARRYING OUT THE INVENTION

The contents of the invention are described in detail hereinunder. In this description, the numerical range expressed by the wording “a number to another number” means the range that falls between the former number indicating the lowermost limit of the range and the latter number indicating the uppermost limit thereof. Organic EL device in the invention means organic electroluminescent device.

The barrier laminate of the invention has at least one inorganic layer and at least one organic layer, wherein at least one inorganic layer comprises an aluminum compound as the main ingredient thereof, at least one organic layer is formed by polymerizing a composition containing at least one monomer having a bi- or more-functional acryloyl group, and the remaining monomer amount in the organic layer is at most 1 g/m².

The barrier laminate of the invention has the function of shielding oxygen and moisture in air. The barrier laminate of the invention has at least one organic layer and at least one inorganic layer. Apart from these layers, the laminate may further contain at least one organic region and/or inorganic region mentioned below. For simplifying the description hereinunder, the organic layer and the organic region are referred to as “organic layer”; and the inorganic layer and the inorganic region are referred to as “inorganic layer”. In case where the laminate comprises plural organic layers and inorganic layers, in general, it is desirable that the organic layers and the inorganic layers are alternately laminated to constitute the laminate.

In case where the laminate comprises a constitution of an organic region and an inorganic region, the regions may form a gradation material layer where the regions continuously change in the thickness direction of the layer. As examples of the gradation material, there are mentioned materials described in Kim et al's report, Journal of Vacuum Science and Technology A Vol. 23 pp. 971-977 (2005 American Vacuum Society); and gradation layers of an organic layer and an inorganic layer laminated with no boundary therebetween as in US Patent Publication No. 2004/46497.

The barrier laminate of the invention may have any other functional layer than the organic layer and the inorganic layer. As examples of the functional layer, preferred are those to be mentioned hereinunder in the section of substrate films.

Not specifically defined, typically, the number of the layers constituting the barrier laminate is preferably from 2 to 30, more preferably 3 to 20.

### (Organic Layer)

Of the barrier laminate of the invention, at least one organic layer is formed by polymerizing a composition containing at least one monomer having a bi- or more-functional acryloyl group. The bi- or more-functional acryloyl group-having monomer is preferably from bifunctional to hexafunctional. The bi- or more-functional acryloyl group-having monomer is preferably a hetero ring-containing monomer. In the invention, the hetero ring is preferably an atomic group of forming a 3- to 6-membered nitrogen and/or oxygen-containing hetero ring. Concretely, it includes pyrrole, pyrazole, triazole, thiazole, isothiazole, benzothiazole, 1,3,4-thiadiazole, 1,2,4-thiadiazole, oxazole, benzoxazole, imidazole, benzisothiazole, thiophene, benzothiophene, pyridine, pyridazine, pyrimidine, pyrazine, indole, quinoline, purine, carbazole, acridine, oxirane (epoxide), oxetane, aziridine, azetidine, furan, oxolane, pyran, oxane, 2-pyrazolin-5-one, pyrazolidine-3,5-dione, imidazolin-5-one, hydantoin, 2- or 4-thiohydantoin, 2-iminoxazolidin-4-one, 2-oxazolin-5-one, 2-thioxazoline-2,4-dione, isorhodanine, rhodanine, indane-1,3-dione, thiophen-3-one, thiophen-3-one-1,1-dioxide, indolin-2-one, indolin-3-one, 2-oxoindazolium, 3,4-dihydroisoquinolin-4-one, 1,3-dioxane-4,6-dione, barbituric acid, 2-thiobarbituric acid, coumarin-2,4-dione, indazolin-2-one, cyanuric acid, isocyanuric acid, Meldrum's acid, etc. These may further have a substituent. The substituent includes an alkyl group (e.g., methyl group, ethyl group, butyl group), an aryl group (e.g., phenyl group), an amino group (e.g., amino group, methylamino group, dimethylamino group, diethylamino group), an alkoxy group (e.g., methoxy group, ethoxy group, butoxy group, 2-ethylhexyloxy group), anacyl group (e.g., acetyl group, benzoyl group, formyl group, pivaloyl group), an alkoxycarbonyl group (e.g., methoxycarbonyl group, ethoxycarbonyl group), a hydroxyl group, a halogen atom (e.g., fluorine atom, chlorine atom, bromine atom, iodine atom), a cyano group, etc. As the substituent, preferred is one not having an oxygen-containing functional group for the reasons mentioned below; and more preferred is an alkyl group.

The bi- or more-functional acryloyl group-having monomer includes a bi- or more-functional acryloyl group-having monomer of epoxyacrylates, urethane acrylates, isocyanuric acid acrylates, pentaerythritol acrylates, trimethylolpropane acrylates, ethylene glycol acrylates, polyester acrylates, etc. Of those, preferred are isocyanuric acid acrylates and epoxyacrylates.

Not specifically defined, the molecular weight of the bi- or more-functional acryloyl group-having monomer is from 150 to 600 when the film formation is attained in a vapor phase. Preferably, the bi- or more-functional acryloyl group-having monomer accounts for at least 50% by mass of the composition in the invention.

The composition in the invention may contain any other monomer than the bi- or more-functional acryloyl group-having monomer. The additional monomer is, for example, a monofunctional monomer, preferably a monofunctional acrylate monomer or a monofunctional methacrylate monomer. Not specifically defined, the molecular weight of the monofunctional acrylate monomer or the monofunctional methacrylate monomer is from 150 to 600 when the film formation is attained in a vapor phase. The monomer mixture may contain one or more such additional monomers. The monofunctional monomer is effective for increasing the conversion in polymerization; but when its content is too much, then it may detract from the hardness of the organic layer to be formed. Preferably, in the composition in the invention, the content of the other monomer than the bi- or more-functional acryloyl group-having monomer is at most 20% by mass.

For forming the organic layer, herein employable is an ordinary solution coating method or vacuum film formation method. The solution coating method includes, for example, a dip coating method, an air knife coating method, a curtain coating method, a roller coating method, a wire bar coating method, a gravure coating method, a slide coating method, and an extrusion coating method of using a hopper as in U.S. Pat. No. 2,681,294. Not specifically defined, the vacuum film formation method is preferably a flash vacuume vaporation method as in U.S. Pat. Nos. 4,842,893, 4,954,371, 5,032,461. The flash vacuum evaporation method is especially useful as having an effect of lowering the dissolved oxygen in monomer and as capable of increasing the conversion in polymerization.

The monomer polymerization method is not specifically defined, for which, for example, preferred is thermal polymerization, light (UV, visible ray) polymerization, electronic beam polymerization, plasma polymerization or their combination. In thermal polymerization, the substrate on which the organic layer is formed must be suitably resistant to heat.

The composition containing a bi- or more-functional acryloyl group-having monomer may contain any other ingredient than the monomer, for example, a polymerization initiator. Preferably, the amount of the polymerization initiator is at least 0.1 mol % of the bi- or more-functional acryloyl group-having monomer, more preferably from 0.5 to 2 mol %. The composition may suitably control the polymerization reaction that follows the reaction of forming active ingredients. In photopolymerization, a photopolymerization initiator may be used. Examples of the photopolymerization initiator are Irgacureseries (e.g., Irgacure 651, Irgacure754, Irgacure184, Irgacure 2959, Irgacure 907, Irgacure 369, Irgacure 379, Irgacure 819) sold by Ciba Specialty Chemicals; Darocure series (e.g., Darocure TPO, Darocure 1173); Quantacure PDO; Ezacure series (e.g., Ezacure TZM, Ezacure TZT) sold by Sartomer.

The light for irradiation is generally UV light from high-pressure mercy lamp or low-pressure mercy lamp. The irradiation energy is preferably at least 0.5 J/cm², more preferably at least 2 J/cm². Since acrylates receive polymerization inhibition by oxygen in air, it is desirable that the oxygen concentration or the oxygen partial pressure during the monomer polymerization is reduced. In case where the oxygen concentration in polymerization is reduced according to a nitrogen purging method, the oxygen concentration is preferably at most 2%, more preferably at most 0.5%. In case where the oxygen partial pressure is reduced according to a pressure reducing method, the total pressure is preferably at most 1000 Pa, more preferably at most 100 Pa. Especially preferred is UV polymerization with energy irradiation of at least 2 J/cm² under a reduced pressure condition of at most 100 Pa.

In the invention, the remaining monomer amount in the organic layer is at most 1 g/m². The value makes it possible to realize better barrier properties. The remaining monomer amount is more preferably at most 0.5 g/m². In the invention, the remaining monomer means the monomer ingredient extracted out into the solvent. The remaining monomer amount is determined as follows: The organic layer is cut into a piece of from 1 to 2 mm square, dipped for extraction in a solvent having an affinity for the remaining monomer in the organic layer for a suitable period of time (for example, 1 hour or more), and analyzed by HPLC. Not specifically defined, the solvent may be any one having an affinity for the remaining monomer. For example, employable are alcohols such as methanol, ketones such as acetone and methyl ethyl ketone (MEK), esters such as ethyl acetate, ethers, amides and other solvent.

Preferably, the organic layer is smooth and has a high film hardness. Preferably, the smoothness of the organic layer is on a level of at most 10 nm, more preferably at most 2 nm in terms of the mean roughness (Ra value) in 10 μm square. Also preferably, the film hardness of the organic layer is on a level of at least HB in terms of the pencil hardness, more preferably at least H.

The organic layer is required to have neither impurities such as particles nor projections. Accordingly, it is desirable that the organic layer is formed in a clean room. Preferably, the degree of cleanness is at most class 10000, more preferably at most class 1000.

The thickness of the organic layer is not specifically defined. However, when too thin, the layer could not be uniform; but when too thick, the layer may be cracked and its barrier capability may lower. From these viewpoints, the thickness of the organic layer is preferably from 10 nm to 2000 nm, more preferably from 100 nm to 1000 nm.

Two or more organic layers may be laminated. In this case, the layers may have the same composition or different compositions. In case where two or more layers are laminated, the individual organic layers are preferably so designed that they fall within the above-mentioned preferred ranges. In addition, as so mentioned hereinabove and as disclosed in US Patent Publication No. 2004/46497, the organic layers may be gradation layers of which the composition changes continuously in the thickness direction of the layer, with no definite boundary to the adjacent inorganic layer.

### (Inorganic Layer)

Of the barrier laminate of the invention, at least one inorganic layer comprises an aluminum compound as the main ingredient thereof, and preferably comprises an aluminum-containing oxide, nitride, carbide, oxinitride, oxicarbide, nitrocarbide or oxinitrocarbide as the main ingredient thereof. The main ingredient as referred to herein means that its weight ratio is the largest in the layer, and in general, it is at least 80% by mass. Of those, more preferred is an aluminum oxide, nitride or oxinitride; even more preferred is aluminum oxide. As a secondary ingredient, the layer may further contain any other element, for example, at least one metal selected from Si, In, Sn, Zn, Ti, Cu, Ce, Ta and the like, and their oxides, nitrides, carbides, oxinitrides, oxicarbides, nitrocarbides, oxinitrocarbides, etc.

For forming the inorganic layer, employable is any method capable of producing the intended thin film. For it, for example, suitable are a coating method, a sputtering method, a vacuum vapor deposition method, an ion plating method, a plasma CVD method and the like; and more preferred is a sputtering method. The sputtering method may readily enhance the adhesiveness and the barrier properties of the inorganic layer formed.

Regarding the method for forming the inorganic layer, concretely employed are the methods described in Japanese Patent No. 3400324, and JP-A 2002-322561 and 2002-361774.

Preferably, the surface smoothness of the inorganic layer formed in the invention is less than 2 nm in terms of the mean roughness (Ra value) in 10 μm square, more preferably at most 1 nm. Accordingly, it is desirable that the inorganic layer is formed in a clean room. Preferably, the degree of cleanness is at most class 10000, more preferably at most class 1000.

Not specifically defined, the thickness of the inorganic layer is preferably within a range of from 5 nm to 500 nm, more preferably from 10 nm to 200 nm. Two or more inorganic layers may be laminated. In this case, the layers may have the same composition or different compositions. In case where two or more layers are laminated, the individual inorganic layers are preferably so designed that they fall within the above-mentioned preferred ranges. In addition, as so mentioned hereinabove and as disclosed in US Patent Publication No. 2004/46497, the inorganic layers may be gradation layers of which the composition changes continuously in the thickness direction of the layer, with no definite boundary to the adjacent organic layer.

### (Lamination of Organic Layer and Inorganic Layer)

The organic layer and the inorganic layer may be laminated by repeated film formation to form the organic layer and the inorganic layer in a desired layer constitution. In case where the inorganic layer is formed according to a vacuum film formation method such as sputtering method, vacuum vapor deposition method, ion plating method or plasma CVD method, then it is desirable that the organic layer is also formed according to a vacuum film formation method such as the above-mentioned flash vapor deposition method. While the barrier layer is formed, it is especially desirable that the organic layer and the inorganic layer are laminated all the time in a vacuum of at most 1000 Pa, not restoring the pressure to an atmospheric pressure during the film formation. More preferably, the pressure is at most 100 Pa, even more preferably at most 50 Pa, still more preferably at most 20 Pa.

### Use of Barrier Laminate:

In general, the barrier laminate of the invention is formed on a support. Selecting the support, the barrier laminate may have various applications. The support includes a substrate film, as well as various devices, optical components, etc. Concretely, the barrier laminate of the invention may be used as a barrier layer of a gas-barrier film. The barrier laminate and the gas-barrier film of the invention may be used for sealing up devices that require gas-barrier performance. The barrier laminate and the gas-barrier film of the invention may be applied to optical components. These are described in detail hereinunder.

### <Gas-Barrier Film>

The gas-barrier film comprises a substrate film and a barrier laminate formed on the substrate film. In the gas-barrier film, the barrier laminate of the invention may be provided only one surface of the substrate film, or may be provided on both surfaces thereof. The barrier laminate of the invention may be laminated in an order of an inorganic layer and an organic layer from the side of the substrate film; or may be laminated in an order of an organic layer and an inorganic layer from it. The uppermost layer of the laminate of the invention may be an inorganic layer or an organic layer.

The gas-barrier film of the invention is a film substrate having a barrier layer that functions to shield oxygen, moisture, nitrogen oxide, sulfur oxide, ozone and others in air.

Not specifically defined, the number of the layers that constitute the gas-barrier film may be typically from 2 layers to 30 layers, more preferably from 3 layers to 20 layers.

The gas-barrier film may have any other constitutive components (e.g., functional layers such as easily-adhesive layer) in addition to the barrier laminate and the substrate film. The functional layer may be disposed on the barrier laminate, or between the barrier laminate and the substrate film, or on the side (back) of the substrate film not coated with the barrier laminate.

### (Plastic Film)

In the gas-barrier film of the invention, the substrate film is generally a plastic film. Not specifically defined in point of the material and the thickness thereof, the plastic film usable herein may be any one capable of supporting the laminate of an organic layer and an inorganic layer; and it may be suitably selected depending on the use and the object thereof. Concretely, the plastic film includes thermoplastic resins such as polyester resin, methacryl resin, methacrylic acid-maleic anhydride copolymer, polystyrene resin, transparent fluororesin, polyimide, fluoropolyimide resin, polyamide resin, polyamidimide resin, polyetherimide resin, cellulose acylate resin, polyurethane resin, polyether ether ketone resin, polycarbonate resin, alicyclic polyolefin resin, polyarylate resin, polyether sulfone resin, polysulfone resin, cycloolefin copolymer, fluorene ring-modified polycarbonate resin, alicyclic-modified polycarbonate resin, fluorene ring-modified polyester resin, acryloyl compound, etc.

In case where the gas-barrier film of the invention is used as a substrate of a device such as an organic EL device to be mentioned hereinunder, it is desirable that the plastic film is formed of a heat-resistant material. Concretely, the plastic film is preferably formed of a heat-resistant transparent material having a glass transition temperature (Tg) of not lower than 100° C. and/or a linear thermal expansion coefficient of at least 40 ppm/° C. Tg and the linear expansion coefficient may be controlled by the additives to the material. The thermoplastic resin of the type includes, for example, polyethylene naphthalate (PEN: 120° C.), polycarbonate (PC: 140° C.), alicyclic polyolefin (e.g., Nippon Zeon's Zeonoa 1600: 160° C.), polyarylate (PAr: 210° C.), polyether sulfone (PES: 220° C.), polysulfone (PSF: 190° C.), cycloolefin copolymer (COC, compound described in JP-A 2001-150584: 162° C.), polyimide (e.g., Mitsubishi Gas Chemical's Neoprim: 260° C.), fluorene ring-modified polycarbonate (BCF-PC, compound described in JP-A 2000-227603: 225° C.), alicyclic-modified polycarbonate (IP-PC, compound described in JP-A 2000-227603: 205° C.), acryloyl compound (compound described in JP-A2002-80616: 300° C. or more) (the parenthesized data are Tg). In particular, for high transparency, use of alicyclic polyolefin and the like is preferred.

In case where the gas-barrier film of the invention is combined with a polarizer for its use, it is desirable that the barrier layer side (on which the laminate containing at least one inorganic layer and at least one organic layer is formed) of the gas-barrier film is made to face the inside of the cell and the film is disposed in the innermost position (adjacent to the device). In this, since the gas-barrier film is disposed nearer to the cell than to the polarizer, the retardation value of the gas-barrier film is important. In use of the gas-barrier film in this embodiment, preferably, the gas-barrier film comprises a substrate film having a retardation of at most 10 nm and this is laminated with a circularly polarizing plate (¼ wavelength plate+(½ wavelength plate)+linear polarizing plate), or the gas barrier film comprises a substrate film having a retardation of from 100 nm to 180 nm and usable as a ¼ wavelength plate and this is laminated with a linear polarizing plate.

The substrate film having a retardation of at most 10 nm includes cellulose triacetate (FUJIFILM's Fujitac), polycarbonate (Teijin Chemical's Pureace, Kaneka's Elmec), cycloolefin polymer (JSR's Arton, Nippon Zeon's Zeonoa), cycloolefin copolymer (Mitsui Chemical's Apel (pellets), Polyplastic's Topas (pellets)), polyarylate (Unitika's U100 (pellets)), transparent polyimide (Mitsubishi Gas Chemical's Neoprim), etc.

As the ¼ wavelength plate, usable is a film prepared by suitably stretching the above-mentioned film so as to have a desired retardation value.

Since the gas-barrier film of the invention is usable in devices such as organic EL devices, the plastic film is transparent, or that is, its light transmittance is generally at least 80%, preferably at least 85%, more preferably at least 90%. The light transmittance may be measured according to the method described in JIS-K7105. Concretely, using an integrating sphere-type light transmittance meter, a whole light transmittance and a quantity of scattered light are measured, and the diffusive transmittance is subtracted from the whole transmittance to obtain the intended light transmittance of the sample.

Even when the gas-barrier film of the invention is used in displays, it does not always require transparency in a case where it is not disposed on the viewers' side. Accordingly in such a case, a nontransparent material may be used for the plastic film. The nontransparent material includes, for example, polyimide, polyacrylonitrile, known liquid-crystal polymer.

Not specifically defined, the thickness of the plastic film for use in the gas-barrier film of the invention may be suitably selected depending on its use. Typically, the thickness may be from 1 to 800 μm, preferably from 10 to 200 μm. The plastic film may have a functional layer such as a transparent conductive layer, a primer layer, etc. The functional layer is described in detail in JP-A 2006-289627, paragraphs [0036] to [0038]. Examples of other functional layers than those are a mat agent layer, a protective layer, an antistatic layer, a planarizing layer, an adhesiveness improving layer, a light shielding layer, an antireflection layer, a hard coat layer, a stress relaxing layer, an antifogging layer, an anti-soiling layer, a printable layer, an easily-adhesive layer, etc.

### (Easily-Adhesive Layer)

The gas-barrier film of the invention may have an easily-adhesive layer. The easily-adhesive layer is a type of primer layer, undercoat layer or subbing layer; and this is provided for the purpose of controlling the interface condition of the laminate. The layer may enhance the adhesiveness of the film.

The easily-adhesive layer indispensably contains a binder, and may optionally contain a mat agent, a surfactant, an antistatic agent, particles for refractivity control, etc.

The binder is not specifically defined, for which, for example, usable are acrylic resin, polyurethane resin, polyester resin, rubber-type resin, etc.

The acrylic resin is a polymer comprising any of acrylic acid, methacrylic acid and their derivatives as the constitutive ingredient thereof. Concretely, for example, it is a copolymer produced through copolymerization of a main ingredient of acrylic acid, methacrylic acid, methyl methacrylate, ethyl methacrylate, butyl acrylate, 2-ethylhexyl acrylate, acrylamide, acrylonitrile, hydroxyacrylate or the like, and a monomer copolymerizable with it (e.g., styrene, divinylbenzene).

The polyurethane resin is a generic term for a polymer having an urethane bond in the main chain thereof, and in general, it is produced through reaction of a polyisocyanate and a polyol. The polyisocyanate includes TDI (tolylene diisocyanate), MDI (methyl diphenyl isocyanate), HDI (hexylene diisocyanate), IPDI (isophorone diisocyanate), etc.; and the polyol includes ethylene glycol, propylene glycol, glycerin, hexanetriol, trimethylolpropane, pentaerythritol, etc.

Further, as the isocyanate in the invention, also usable is a polymer produced by further processing a polyurethane polymer, obtained through reaction of a polyisocyanate and a polyol, for chain prolongation to thereby increase the molecular weight thereof. The polyester resin is a generic term for a polymer having an ester bond in the main chain thereof, and is generally obtained through reaction of a polycarboxylic acid and a polyol. The polycarboxylic acid includes, for example, fumaric acid, itaconic acid, adipic acid, sebacic acid, terephthalic acid, isophthalic acid, naphthalenedicarboxylic acid, etc.; and the polyol includes those mentioned in the above.

The rubber-type resin for use in the invention means a diene-based synthetic rubber, a type of synthetic rubber. Its specific examples include polybutadiene, styrene-butadiene copolymer, styrene-butadiene-acrylonitrile copolymer, styrene-butadiene-divinylbenzene copolymer, butadiene-acrylonitrile copolymer, polychloroprene, etc.

The water vapor permeability of the gas-barrier film of the invention at 40° C. and a relative humidity of 90% is preferably at most 0.01 g/m²day, more preferably at most 0.001 g/m²-day, even more preferably at most 0.0001 g/m²·day.

### <Device>

The barrier laminate and the gas-barrier film of the invention are favorably used for devices that are deteriorated by the chemical components in air (e.g., oxygen, water, nitrogen oxide, sulfur oxide, ozone). Examples of the devices are, for example, organic EL devices, liquid-crystal display devices, thin-film transistors, touch panels, electronic papers, solar cells, and other electronic devices. More preferred are organic EL devices.

The barrier laminate of the invention may be used for film-sealing of devices. Specifically, this is a method of providing a barrier laminate of the invention on the surface of a device serving as a support by itself. Before providing the barrier laminate, the device may be covered with a protective layer.

The gas-barrier film of the invention may be used as a substrate of a device or as a film for sealing up according to a solid sealing method. The solid sealing method comprises forming a protective layer on a device, then forming an adhesive layer and a gas-barrier film as laminated thereon, and curing it. Not specifically defined, the adhesive may be a thermosetting epoxy resin, a photocurable acrylate resin, etc.

### (Organic EL Device)

Examples of an organic EL device with a gas-barrier film are described in detail in JP-A 2007-30387.

### (Liquid-Crystal Display Device)

A reflection-type liquid-crystal display device has a constitution of a lower substrate, a reflection electrode, a lower alignment film, a liquid-crystal layer, an upper alignment film, a transparent electrode, an upper substrate, a λ/4 plate and a polarizing film, formed in that order from the bottom. In this, the gas-barrier film of the invention may be used as the transparent electrode substrate and the upper substrate. In color displays, it is desirable that a color filter layer is additionally provided between the reflection electrode and the lower alignment film, or between the upper alignment film and the transparent electrode. A transmission-type liquid-crystal display device has a constitution of a backlight, a polarizer, a λ/4 plate, a lower transparent electrode, a lower alignment film, a liquid-crystal layer, an upper alignment film, an upper transparent electrode, an upper substrate, a λ/4 plate and a polarizing film, formed in that order from the bottom. In this, the substrate of the invention may be used as the upper transparent electrode and the upper substrate. In color displays, it is desirable that a color filter layer is additionally provided between the lower transparent electrode and the lower alignment film, or between the upper alignment film and the transparent electrode. Not specifically defined, the type of the liquid-crystal cell is preferably a TN (twisted nematic) type, an STN (super-twisted nematic) type, a HAN (hybrid aligned nematic) type, a VA (vertically alignment) type, an ECB (electrically controlled birefringence) type, an OCB (optically compensated bend) type, a CPA (continuous pinwheel alignment) type, or an IPS (in-plane switching) type.

### (Others)

Other applications of the invention are thin-film transistors as in JP-T 10-512104, touch panels as in JP-A 5-127822, 2002-48913, electronic papers as in JP-A 2000-98326, and solar cells as in Japanese Patent Application No. 7-160334.

### <Optical Component>

An example of the optical component that comprises the gas-barrier film of the invention is a circular polarizer.

### (Circular Polarizer)

Laminating a gas-barrier film of the invention with a λ/4 plate and a polarizer gives a circular polarizer. In this case, the components are so laminated that the slow axis of the λ/4 plate could cross the absorption axis of the polarizer at an angle of 45°. The polarizer is preferably stretched in the direction of 45° from the machine direction (MD) thereof; and for example, those described in JP-A 2002-86554 are favorably used.

### EXAMPLES

The invention is described more concretely with reference to the following Examples. In the following Examples, the material used, its amount and the ratio, the details of the treatment and the treatment process may be suitably modified or changed not overstepping the sprit and the scope of the invention. Accordingly, the invention should not be limitatively interpreted by the Examples mentioned below.

### Example 1

### (Formation of Organic/Inorganic Laminate-Type Gas-Barrier Film)

A polyethylene naphthalate film (PEN film, Teijin DuPont's trade name, Teonex Q65FA, having a thickness of 200 μm) was cut into 20 cm square pieces, and a barrier laminate comprising an organic layer and an inorganic layer mentioned below was formed on the side of the smooth surface thereof.

Using an organic/inorganic laminate film formation device (Vitex Systems' Guardian 200), a composition comprising a monomer (100 g) and a polymerization initiator (ESACURE-TZT, 5 g) shown in Table 1 was applied on the side of the smooth surface of the substrate film, according to a flash vapor deposition method. Then, this was irradiated with UV rays and polymerized to form an organic layer. The thickness of the layer formed was 1.1 μm. The UV irradiation energy for polymerization was 2 J/cm².

Guardian 200 is an apparatus for forming an organic/inorganic laminate-type barrier laminate. In this, an organic layer and an inorganic layer are formed continuously all in vacuum, and therefore, the barrier laminate to be produced therein is not exposed to open air until the completion of its production. In this Example, the degree of cleanness in the clean room was kept all the time at a class of 1000.

Next, using the organic/inorganic laminate film formation device (Guardian 200) and not taking out the substrate film from the vacuum condition therein, an inorganic layer was formed on the organic layer. The inorganic layer is an aluminum oxide film formed according to a reactive sputtering method (in this, the reactive gas is oxygen) with a direct-current pulse given to an aluminum target. The thickness of the formed inorganic layer was 40 nm. In case where a silicon oxide film is formed as the inorganic layer, the target is changed to silicon and the others are the same as above.

The above operation was repeated, and four organic layers and three inorganic layers were alternately laminated in an order of an organic layer and an inorganic layer from the side near to the substrate film, thereby producing an organic/inorganic laminate-type gas-barrier film.

### (Production of Organic EL Device)

The gas-barrier film formed in the above was used as a substrate. Using an ITO target, a transparent electrode of an ITO thin film having a thickness of 0.2 μm was formed by DC magnetron sputtering. The following organic compound layers were formed in order on the side of the ITO electrode (anode) of the transparent conductive film, according to a vacuum vapor deposition method.

### (First Hole Transportation Layer)

Copper Phthalocyanine: thickness 10 nm

### (Second Hole Transportation Layer)

N,N′-diphenyl-N,N′-dinaphthylbenzidine: thickness 40 nm

### (Light Emission Layer Serving Also as Electron Transportation Layer)

Tris(8-hydroxyquinolinato)aluminum: thickness 60 nm

Finally, lithium fluoride was vapor-deposited in a thickness of 1 nm and metal aluminum was in a thickness of 100 nm in that order, serving as a cathode. On this, a silicon nitride film having a thickness of 3 μm was formed according to a parallel plate CVD method, thereby constructing an organic EL device.

### Sealing of Organic EL Device:

On the silicon nitride film of the organic EL device produced in the manner as above, a barrier laminate was formed in the same manner as in the above, thereby sealing up the organic EL device.

### Method of Measurement of Monomer Residue:

The gas-barrier film produced in the above was cut into pieces of 1 to 2 mm square, then dipped in methanol for at least 1 hour, and left in an ultrasonic tank to thereby extract the remaining monomer. For HPLC, used was Shimadzu's C-R7A, and the column was Showa Denko's Shodex ODS-C18M. The solution extract was analyzed to determine the amount of the remaining monomer (extracted ingredient). When the solvent was removed from the extracted ingredient and the residue was quantitatively determined, the same result was also obtained. Method for Evaluation of Durability of Organic EL Device:

Immediately after their production, the organic EL devices were driven for light emission at a voltage of 7V applied thereto, using a source measure unit, Keithley's SMU2400 Model. Using a microscope, the surface of each sample was checked for its condition with light emission, and it was confirmed that all the devices gave uniform light emission with no dark spot.

Next, the devices were kept in a dark room at 60° C. and a relative humidity of 90% for 500 hours, and checked for the surface condition with light emission. The driven samples were visually checked for the presence or absence of dark spots. The samples were evaluated in 5 ranks; and 5 is the best. 3 or more is on a practicable level; and 5 means good durability over detection limit.

TABLE 1

| | | | | Evaluation |
|---|---|---|---|---|
| | | | | for |
| | | | | Durability |
| Sample | Monomer of | Monomer | Inorganic | of Organic |
| No. | Organic Layer | Residue | Layer | EL Device |
| 1 | M315 | not more than | aluminum | 5 |
| | | 1 g/m² | oxide | |
| 2 | M215 | not more than | aluminum | 5 |
| | | 1 g/m² | oxide | |
| 3 | EBECRYL3420 | not more than | aluminum | 4 |
| | | 1 g/m² | oxide | |
| 4 | M315 | not less than | aluminum | 1 |
| | | 1 g/m² | oxide | |
| 5 | M315 | not more than | silicon | 1 |
| | | 1 g/m² | oxide | |
| 6 | M315 | not less than | silicon | 1 |
| | | 1 g/m² | oxide | |

M315 is an isocyanuric acid EO-modified isotriacrylate (by Toa Gosei);
M215 is an isocyanuric acid EO-modified diacrylate (by Toa Gosei).
EBECRYL3420 is an epoxyacrylate (by Daicel Cytec).

The gas-barrier film of the invention was analyzed for the water vapor permeation thereof according to a MOCON method (JIS K7129, 1992), and it was less than 0.01 g/m²/day. It is known that the gas-barrier film of the invention has an extremely high gas-barrier capability. The film was tested in a peeling test, which confirmed excellent adhesiveness of the samples of the invention.

When any one of the substrate or the laminate for sealing of an organic EL device was changed to a glass substrate, the same effect of the invention was also confirmed in the modified device.

### Example 2

(Formation of Gas-Barrier Film having Low-Retardation Substrate Film)

Gas-barrier films were produced in the same manner as in Table 1, for which, however, the substrate film used in Example 1, a polyethylene naphthalate film (PEN film, Teijin-DuPont's Teonex Q65FA) was changed to any of four different films, a cycloolefin polymer film (COP film, Nippon Zeon's trade name Zeonoa ZF-16), a transparent polyimide film (PI film, Mitsubishi Gas Chemical's trade name, Neoprim), and polycarbonate films (Teijin Chemical's trade name, Pureace T-138 (¼ wavelength plate), and Panlite D-92). All the gas-barrier films of the invention, as produced by the use of any of the above substrate films, has good durability, and it is known that they have excellent barrier properties. Like in Example 1, it is also known that the barrier films of the invention also have excellent adhesiveness.

According to the invention, it has become possible to provide a barrier laminate having good barrier properties which conventional barrier laminates could not have. When the barrier laminate of the invention is provided on a substrate film, a gas-barrier film having good barrier properties can be provided. In particular, the gas-barrier film of the invention can be thinned and its weight can be reduced.

Accordingly, the gas-barrier film of the invention is favorably used in electronic devices such as organic EL devices, and other devices and optical components such as solar cells, touch panels, electronic papers, etc.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 336104/2007 filed on Dec. 27, 2007 and No. 47534/2008 filed on Feb. 28, 2008, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A barrier laminate comprising at least one inorganic layer and at least one organic layer, wherein the inorganic layer comprises an aluminum compound as a main ingredient thereof, the organic layer is formed by polymerizing a composition containing at least one monomer having a bi- or more-functional acryloyl group, and the organic layer contains a remaining monomer in at most 1 g/m².

2. The barrier laminate according to claim 1, wherein the acryloyl group-having monomer is a hetero ring-containing monomer.

3. The barrier laminate according to claim 1, wherein the acryloyl group-having monomer is an isocyanuric acid acrylate or an epoxyacrylate.

4. The barrier laminate according to claim 1, wherein the inorganic layer comprises aluminum oxide as a main ingredient thereof.

5. The barrier laminate according to claim 1, wherein the inorganic layer is formed by a sputtering method.

6. The barrier laminate according to claim 1, wherein the composition containing a monomer having a bi- or more-functional acryloyl group contains a polymerization initiator and the content of the polymerization initiator is at least 1 mol % of the bi- or more-functional acryloyl group-having monomer.

7. A gas-barrier film comprising the barrier laminate of claim 1 on a substrate film.

8. A device comprising the barrier laminate of claim 1.

9. The device according to claim 8 comprising the barrier laminate on a substrate film.

10. The device according to claim 8 sealed with the barrier laminate.

11. The device according to claim 9 wherein the barrier laminate on a substrate film is used as a substrate.

12. The device according to claim 9 sealed with the barrier laminate on a substrate.

13. The device according to claim 8, wherein the device is an electronic device.

14. The device of claim 8, wherein the device is an organic EL device.

15. An optical component comprising the gas-barrier film of claim 7 as a substrate.
